(19) United States
(12) Patent Application Publication
(10) Pub. No.: US 2015/0024117 A1
(43) Pub. Date: Jan. 22, 2015

(54) VACUUM DRYING APPARATUS AND METHOD OF MANUFACTURING DISPLAY APPARATUS BY USING THE SAME

(71) Applicant: Samsung Display Co., Ltd., Yongin-City (KR)

(72) Inventor: Yong-Il Kim, Yongin-City (KR)

(73) Assignee: Samsung Display Co., Ltd., Yongin-City (KR)

(21) Appl. No.: 14/077,003

(22) Filed: Nov. 11, 2013

(30) Foreign Application Priority Data
Jul. 22, 2013 (KR) 10-2013-0086271

(51) Int. Cl. F26B 21/10; B05D 3/04; F26B 5/04

(52) U.S. Cl. CPC F26B 21/10; F26B 5/04; B05D 3/0493
USPC 427/8; 34/92; 34/559; 34/558

(57) ABSTRACT

A vacuum drying apparatus and a method of manufacturing a display apparatus by using the same. A vacuum drying apparatus according to embodiments of the present invention includes a chamber having a space formed therein, a support unit that is installed in the chamber and on which a substrate coated with a treatment solution is stably placed, a gas injection unit that is connected to the chamber to inject a treatment gas into the chamber, a decompression unit that is connected to the chamber to decompress the chamber, and a gas sensing unit that is installed with at least one of the chamber and the decompression unit to detect gas generated during drying of the treatment solution.

### CROSS-REFERENCE TO RELATED APPLICATION

This application claims priority to and the benefit of Korean Patent Application No. 10-2013-0086271, filed on Jul. 22, 2013, in the Korean Intellectual Property Office, the content of which is incorporated herein in its entirety by reference.

### BACKGROUND

1. Field

One or more embodiments of the present invention relate to an apparatus and a method, and more particularly, to a vacuum drying apparatus and a method of manufacturing a display apparatus by using the same.

2. Description of the Related Art

Portable electronic devices have been widely used. Recently, tablet PCs have been widely used as a portable electronic device, in addition to small electronic devices, such as mobile phones.

Such portable electronic devices include a display apparatus that supports various functions and provides visual information, such as images or pictures, to a user.

The display apparatus may display images by having various structures formed on a substrate and emitting light to the outside. In this case, various processes may be performed to form the various structures on the substrate.

In particular, a process of coating the substrate with a treatment solution, such as a resist solution, and a process of drying the treatment solution are performed. Then, a structure may be formed by performing a number of suitable processes, such as photolithography, etching, or ashing. Also, in addition to the above case, a structure may be formed by simply coating with a treatment solution and then drying the treatment solution.

### SUMMARY

Aspects of one or more embodiments of the present invention are directed toward a vacuum drying apparatus that may monitor, in real time, gas generated during drying of a substrate, and a method of manufacturing a display apparatus by using the same.

Additional aspects will be set forth in part in the description which follows and, in part, will be apparent from the description, or may be learned by practice of the presented embodiments.

According to one or more embodiments of the present invention, a vacuum drying apparatus includes: a chamber having a space formed therein; a support unit installed in the chamber to stably support a substrate coated with a treatment solution; a gas injection unit connected to the chamber to inject a treatment gas into the chamber; a decompression unit connected to the chamber to decompress the chamber; and a gas sensing unit installed on at least one of the chamber and the decompression unit to detect gas generated during drying of the treatment solution.

The chamber may include a first housing and a second housing separably joined with the first housing.

The vacuum drying apparatus may further include a moving part connected to the first housing to detach the first housing from the second housing.

The support unit may include a support plate to support the substrate, and a support shaft to support the support plate.

The vacuum drying apparatus may further include seating pins installed in the chamber to support the substrate.

The decompression unit may include a suction pipe connected to the chamber to guide gas in the chamber to the outside, and a suction pump installed in the suction pipe.

The gas sensing unit may be installed in the suction pipe.

The gas sensing unit may be installed on an upper side of the chamber.

The vacuum drying apparatus may further include a controller to control an operation of the decompression unit based on a gas concentration detected by the gas sensing unit.

The controller may be configured to stop the operation of the decompression unit when the gas concentration is less than a set concentration.

The controller may be configured to operate the gas injection unit to inject the treatment gas into the chamber when the operation of the decompression unit is stopped.

The controller may be configured to calculate a gas generation rate and may control the operation of the decompression unit based on the calculated gas generation rate.

The controller may be configured to control the operation of the decompression unit to increase pressure in the chamber when the gas generation rate is determined to exceed a set rate.

According to one or more embodiments of the present invention, a method of manufacturing a display apparatus includes: coating a substrate with a treatment solution; loading the substrate into a chamber; and drying the treatment solution on the substrate while decompressing the chamber, wherein at least one of a gas in the chamber and a gas discharged from the chamber is measured in the drying of the treatment solution.

The chamber may include a first housing and a second housing separably joined with the first housing, and the method may further include loading the substrate in a state in which the first housing and the second housing are separated, and joining the first housing and the second housing after the loading of the substrate is completed.

The method may further include injecting a treatment gas into the chamber when a gas concentration in the chamber is less than a set concentration.

The method may further include calculating a gas generation rate in the chamber.

The method may further include maintaining or increasing pressure in the chamber when the gas generation rate is determined to exceed a set rate.

The method may further include displaying a measured amount of the generated gas.

The measurement of the gas may be performed on an upper side of the chamber.

### BRIEF DESCRIPTION OF THE DRAWINGS

These and/or other aspects will become apparent and more readily appreciated from the following description of the embodiments, taken in conjunction with the accompanying drawings in which:

FIG. 1 is a conceptual view illustrating a vacuum drying apparatus according to an embodiment of the present invention;

FIG. 2 is a conceptual view illustrating a vacuum drying apparatus according to another embodiment of the present invention; and

FIG. 3 is a cross-sectional view illustrating a display apparatus manufactured using the vacuum drying apparatuses according to an embodiment of the present invention.

### DETAILED DESCRIPTION

Reference will now be made in more detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

The present invention will be clarified through the following embodiments described with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. Further, the present invention is only defined by the scope of the claims, and equivalents thereof. The terminology used herein is for the purpose of describing particular example embodiments only and is not intended to be limiting of the present invention. As used herein, the singular forms “a”, “an”, and “the” are intended to include the plural forms as well, unless the context clearly indicates otherwise. It will be further understood that the terms “comprises” and/or “comprising” used herein specify the presence of stated features or components, but do not preclude the presence or addition of one or more other features or components. It will be understood that when a layer, region, or component is referred to as being “formed on” another layer, region, or component, it can be directly or indirectly formed on the other layer, region, or component. That is, for example, intervening layers, regions, or components may be present. It will be understood that although the terms “first”, “second”, etc. may be used herein to describe various components, these components should not be limited by these terms. These components are only used to distinguish one component from another. Expressions such as “at least one of,” when preceding a list of elements, modify the entire list of elements and do not modify the individual elements of the list. Further, the use of “may” when describing embodiments of the present invention refers to “one or more embodiments of the present invention.”

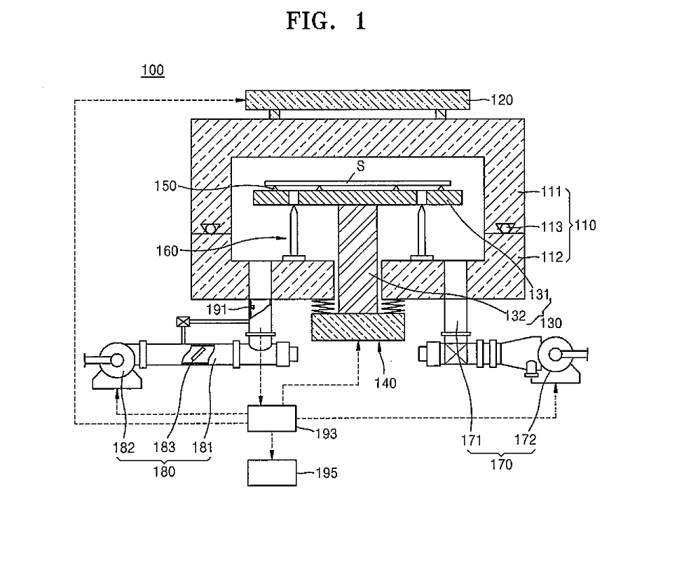

FIG. 1 is a conceptual view illustrating a vacuum drying apparatus 100 according to an embodiment of the present invention.

Referring to FIG. 1, the vacuum drying apparatus 100 may include a chamber 110 having a space formed therein. The chamber 110 may include a first housing 111 and a second housing 112.

The first housing 111 and the second housing 112 may be separably joined. In particular, the first housing 111 and the second housing 112 may be separated according to loading or unloading of a substrate S. Also, the first housing 111 and the second housing 112 may close the space in the chamber 110 from the outside when joined together during a drying process.

The chamber 110 may include a sealing portion 113 installed between the first housing 111 and the second housing 112. The sealing portion 113, as a portion with which the first housing 111 and the second housing 112 are joined during the joining of the first housing 111 and the second housing 112, may prevent the leakage of gas from the chamber 110. In particular, the sealing portion 113 may include an O-ring and may be formed of an elastic material, such as silicone or rubber.

The vacuum drying apparatus 100 may include a moving part 120 connected to the first housing 111. In this case, the moving part 120 may detach the first housing 111 from the second housing 112 and may also maintain the joining of the first housing 111 and the second housing 112.

The moving part 120 may be variously formed. For example, the moving part 120 may include a first cylinder, or may include a first motor and a first gear unit that is connected to the first motor. However, hereinafter, the embodiment of the present invention will be described in more detail for a case where the moving part 120 includes the first cylinder for convenience in description.

The vacuum drying apparatus 100 may include a support unit 130 installed in the chamber 110. In this case, the substrate S coated with a treatment solution may be stably placed on the support unit 130. The support unit 130 may include a support plate 131 on which the substrate S is disposed. The support plate 131 may be formed larger than (an area of) the substrate S, and may support the substrate S by direct contact with the substrate S or may support the substrate S by a separate structure.

The support unit 130 may include a support shaft 132 that supports the support plate 131 by being connected to the support plate 131. The support shaft 132 may be installed to penetrate the second housing 112, and may be installed on the second housing 112 to be fixed thereto or to be linearly movable.

In particular, when the support shaft 132 is installed on the second housing 112 to be linearly movable, the vacuum drying apparatus 100 may include a first driver 140 that linearly moves the support shaft 132. In this case, the first driver 140 may include a second motor and a second gear unit that transmits a driving force according to the drive of the second motor, or may include a second cylinder. However, hereinafter, the embodiment of the present invention will be described in more detail for a case where the first driver 140 includes the second cylinder for convenience in description.

The vacuum drying apparatus 100 may include spacing pins 150 that are installed on the support unit 130 to support the substrate S. The spacing pins 150 may be installed on the support plate 131 to protrude from a surface of the support plate 131 toward the substrate S. Also, the spacing pins 150 may be installed to be fixed to the surface of the support plate 131 or to be linearly movable. However, hereinafter, the embodiment of the present invention will be described in more detail for a case where the spacing pins 150 are installed to be fixed to the surface of the support plate 131 for convenience in description.

The spacing pin 150 may be included in plurality. The spacing pins 150 may be installed on the surface of the support plate 131 to be spaced apart from one another. In this case, the spacing pins 150 may be installed on the surface of the support plate 131 to uniformly support a surface of the substrate S. In particular, when a size of the substrate S is large, such as about 40 inches or more, the spacing pins 150 may prevent the substrate S from bending toward the support plate 131 or being deformed.

The vacuum drying apparatus 100 may include seating pins 160 that are installed in the chamber 110 to support the substrate S. In this case, the seating pin 160 may be installed to penetrate the support plate 131. Also, the seating pin 160 may be included in plurality, and the seating pins 160 may be spaced apart from one another to support the substrate S.

In particular, the seating pins 160 may temporarily support the substrate S when the substrate S is first loaded in the chamber 110 or when the drying process is completed.

The seating pins 160 may be installed in the chamber 110 to be linearly movable. In this case, the seating pin 160 is connected to a second driver, and the second driver may linearly move the seating pin 160. The second driver may include a third cylinder, or may include a third motor and a third gear unit that is connected to the third motor to transmit a driving force. The seating pins 160 may be installed to be fixed to the chamber 110. In the case above, the seating pin 160 and the support plate 131 may move relative to each other. However, hereinafter, the embodiment of the present invention will be described in more detail for a case where the seating pins 160 are fixed to the chamber 110 for convenience in description.

The vacuum drying apparatus 100 may include a gas injection unit 170 that is connected to the chamber 110 to inject a treatment gas into the chamber 110. The gas injection unit 170 may include a gas reservoir, in which the treatment gas is stored, an injection pipe 171 connecting the gas reservoir and the chamber 110, and a supply pump 172 installed on the injection pipe 171.

The vacuum drying apparatus 100 may include a decompression unit 180 that is connected to the chamber 110 to decompress the atmosphere in the chamber 110. The decompression unit 180 may include a suction pipe 181 that is connected to the chamber 110 to guide gas in the chamber 110 to the outside, and a suction pump 182 installed on the suction pipe 181. Also, the decompression unit 180 may include a control valve 183 controlling an opening of the suction pipe 181.

The vacuum drying apparatus 100 may include a gas sensing unit 191 that is installed on at least one of the chamber 110 and the decompression unit 180 to detect gas generated during the drying of the treatment solution. The gas sensing unit 191 may include at least one of a contact sensor and a non-contact sensor. In particular, the contact sensor may include a semiconductor sensor and a catalytic sensor, and the non-contact sensor may include an infrared sensor. In particular, since the semiconductor sensor, catalytic sensor, or infrared sensor may sense gas identically or similarly to a typical semiconductor sensor, catalytic sensor, or infrared sensor, a detailed description thereof is omitted. Also, hereinafter, the embodiment of the present invention will be described in more detail for a case where the gas sensing unit 191 is installed on the decompression unit 180 and includes the contact sensor for convenience in description.

The gas sensing unit 191 may be installed on the decompression unit 180. In particular, the gas sensing unit 191 may detect gas passing through the suction pipe 181 when installed on the suction pipe 181 of the decompression unit 180. The gas sensing unit 191 may detect a concentration of the gas flowing in the suction pipe 181 and an amount of the discharged gas.

The vacuum drying apparatus 100 may include a controller 193 that controls an operation of the decompression unit 180 based on the concentration of the gas detected by the gas sensing unit 191. The controller 193 may include any apparatus that is suitable to control the vacuum drying apparatus 100, such as a personal computer, a notebook, or a portable terminal.

Hereinafter, an operation sequence of the vacuum drying apparatus 100 will be described in more detail. The substrate S is first coated with a treatment solution, for example, before performing a process of forming a pattern on the substrate S or after performing a separate deposition process, an organic emission layer formation process, or a thin film process, and the treatment solution may then be dried by the vacuum drying apparatus 100. Specifically, when the substrate S is coated with the treatment solution, the substrate S may be loaded in the chamber 110 from the outside through a transport unit, such as a carrier, a shuttle, or a robot arm.

The moving part 120 may lift the first housing 111 to separate the first housing 111 from the second housing 112. In particular, when the first housing 111 and the second housing 112 are separated, the inside of the chamber 110 may be maintained at atmospheric pressure by the treatment gas supplied from the gas injection unit 170.

When the first housing 111 and the second housing 112 are separated, the first driver 140 may move the support plate 131 to a bottom portion of the second housing 112. In this case, the seating pins 160 may protrude higher than a top of the support plate 131. The transport unit transports the substrate S to the seating pins 160 and may then stably place the substrate S on the seating pins 160.

When the above process is completed, the transport unit may be taken out to the outside of the chamber 110. In this case, the moving part 120 may lower the first housing 111 to join the first housing 111 and the second housing 112 together. In particular, the inside of the chamber 110 may be completely closed due to the joining of the first housing 111 and the second housing 112.

When the closing of the chamber 110 is completed, the controller 193 may control the first driver 140 to move the support plate 131 upward. When the top of the support plate 131 and the end portions of the seating pins 160 are almost leveled, the substrate S may be in contact with the spacing pins 150 to be stably placed on the spacing pins 150. When the substrate S is stably placed on the spacing pins 150, the treatment solution on the substrate S may be dried while the decompression unit 180 decompresses the atmosphere in the chamber 110. In this case, the controller 193 may control the suction pump 182 to sequentially decompress the atmosphere in the chamber 110.

The controller 193 may control the suction pump 182 to adjust pressure in the chamber 110 to be a first pressure from the atmospheric pressure. Also, when the pressure in the chamber 110 becomes the first pressure, the controller 193 may control the suction pump 182 to adjust the pressure in the chamber 110 to be a second pressure from the first pressure. The first pressure may be lower than the atmospheric pressure, and the second pressure may be lower than the first pressure. The controller 193 may control the suction pump 182 to sequentially reduce the pressure in the chamber 110 such that the pressure in the chamber 110 is in a vacuum state or close to a vacuum state by stepwise decreasing the second pressure to a third pressure, a fourth pressure, . . . , and an Nth pressure (where N is a natural number).

When the pressure in the chamber 110 decreases as described above, a boiling point of the treatment solution (e.g., the solvent) may decrease. Therefore, the treatment solution may vaporize at a low temperature, and may be dried by being vaporized in a decompressed (vacuum) state. When the treatment solution is vaporized, gas may be generated from the treatment solution. In particular, gas may be generated by vaporization of some components included in the treatment solution, and thus, the gas may be discharged into the chamber 110. The discharged gas may be exhausted to the outside through the suction pipe 181 according to the operation of the suction pump 182.

The gas sensing unit 191 may measure the gas flowing in the suction pipe 181 during the drying process of the treatment solution on the substrate S. As described above, the gas sensing unit 191 may measure the amount of the discharged gas and the concentration of the gas.

Data, such as the amount of the discharged gas and the concentration of the gas, may be transmitted to the controller 193. The controller 193 may control the operation of the suction pump 182 based on the gas concentration detected by the gas sensing unit 191.

The controller 193 may stop the operation of the decompression unit 180 when the gas concentration detected by the gas sensing unit 191 is less than a predetermined or set concentration. In particular, the predetermined or set concentration may be a concentration of the gas passing through the suction pipe 181 when the vacuum drying is completed, and may be a concentration of the gas measured in an experiment or actual process.

Therefore, when the controller 193 determines that the detected gas concentration is less than the predetermined or set concentration, the controller 193 may determine that the drying process of the treatment solution is completed. In this case, the controller 193 may control to stop the operation of the suction pump 182.

The controller 193 may calculate a gas generation rate based on the amount of the generated gas detected by the gas sensing unit 191. The gas generation rate may be calculated from the amount of the generated gas per unit time.

The controller 193 may control the operation of the decompression unit 180 based on the gas generation rate calculated as described above. Specifically, when the gas generation rate is determined to exceed a predetermined or set rate, the controller 193 may control the operation of the decompression unit 180 to increase the pressure in the chamber 110.

For example, when the gas generation rate is determined to exceed the predetermined set rate, the controller 193 may determine that the drying of the treatment solution is excessively fast. In particular, when the gas generation rate exceeds the predetermined or set rate as described above, the pressure in the chamber 110 may be excessively low, and thus, a large amount of the gas discharged during the vaporization of the treatment solution may be generated. Also, in the case above, a large amount of air bubbles may be generated in the treatment solution on the substrate S, and the surface uniformity of the treatment solution may be damaged as the air bubbles break or explode. Therefore, the controller 193 may control the pressure in the chamber 110 by controlling the decompression unit 180 according to the gas generation rate.

The controller 193 may stop or reduce the operation of the suction pump 182. Therefore, when the operation of the suction pump 182 is stopped, the pressure in the chamber 110 may increase due to the gas generated from the treatment solution and thus, an evaporation rate of the treatment solution may be controlled. In addition, when the operation of the suction pump 182 is reduced, a rate at which the pressure in the chamber 110 decreases may be adjusted due to the control of the evaporation rate of the treatment solution, similar to the case above.

The controller 193 may convert the gas generation rate, the amount of the generated gas, or the gas concentration, in real time, into data according to time and temperature, and may store the data. Also, the controller 193 may display the stored data to the outside on a display unit 195.

When the controller 193 determines that the drying process is completed, the controller 193 may control the gas injection unit 170 to provide the treatment gas into the chamber 110. The controller 193 operates the supply pump 172, and the supply pump 172 may supply the treatment gas from the gas reservoir into the chamber 110 through the injection pipe 171. The treatment gas may be an inert gas, such as helium, argon, or nitrogen.

When the treatment gas is provided into the chamber 110, the pressure in the chamber 110 may be changed into a pressure similar to the atmospheric pressure. Also, the controller 193 may operate the first driver 140 to lower the support plate 131. When the support plate 131 is lowered, one end of each of the seating pins 160 protrudes from the top of the support plate 131 and the seating pins 160 may support the substrate S.

When the pressure in the chamber 110 is the same as the atmospheric pressure, the moving part 120 may open the chamber 110 by lifting the first housing 111. In this case, the transport unit may be inserted between the first housing 111 and the second housing 112 to take the substrate S that is stably placed on the seating pins 160 out to the outside of the chamber 110. Therefore, the vacuum drying apparatus 100 may monitor and analyze the gas generated during the drying of the treatment solution by measuring the gas in real time. Also, the vacuum drying apparatus 100 may be controlled based on the gas concentration and the gas generation rate, and thus, the vacuum drying apparatus 100 may perform the drying of the treatment solution under suitable or optimum process conditions.

In addition, since the vacuum drying apparatus 100 may perform the drying process under suitable or optimum process conditions, drying time and energy required during the drying may be saved.

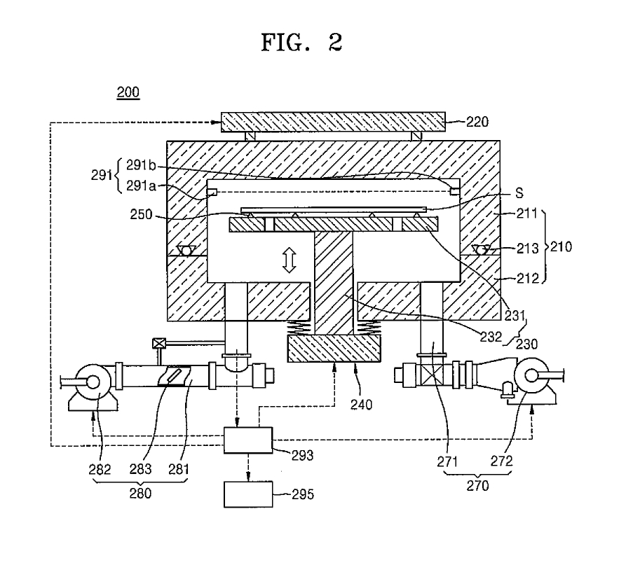

FIG. 2 is a conceptual view illustrating a vacuum drying apparatus 200 according to another embodiment of the present invention.

Referring to FIG. 2, the vacuum drying apparatus 200 may include a chamber 210, a moving part 220, a support unit 230, a first driver 240, spacing pins 250, a gas injection unit 270, a decompression unit 280, a gas sensing unit 291, and a controller 293. The chamber 210, the moving part 220, the support unit 230, the first driver 240, the spacing pins 250, the gas injection unit 270, the decompression unit 280, and the controller 293 are identical or similar to the chamber 110, the moving part 120, the support unit 130, the first driver 140, the spacing pins 150, the gas injection unit 170, the decompression unit 180, and the controller 193, which are described with reference to FIG. 1, and thus, a detailed description thereof is not provided again.

The chamber 210 may include a first housing 211, a second housing 212, and a sealing portion 213, and the support unit 230 may include a support plate 231 and a support shaft 232. Also, the gas injection unit 270 may include a gas reservoir, an injection pipe 271, and a supply pump 272, and the decompression unit 280 may include a suction pipe 281, a suction pump 282, and a control valve 283.

The gas sensing unit 291 may include a light source part 291a that emits light to the outside. Also, the gas sensing unit 291 may include an optical sensor part 291b that senses the light emitted from the light source part 291a. The gas sensing unit 291 may be disposed on an upper side of the chamber 210. Specifically, the gas sensing unit 291 may be installed on an upper end of the first housing 211. In particular, since the optical sensor part 291b measures the wavelength and intensity of the light emitted from the light source part 291a, the gas sensing unit 291 may measure a concentration of the gas or an amount of the generated gas.

In the operation of the vacuum drying apparatus 200, a substrate S is first coated with a treatment solution, and the substrate S may then be loaded in the chamber 210 through a transport unit.

The controller 293 may operate the moving part 220 to separate the first housing from the second housing 212 and open the chamber 210. Also, the controller 293 may operate the first driver 240 to raise the support plate 231.

The substrate S loaded in the chamber 210 by the transport unit may be disposed on the support plate 231. In particular, the substrate S may be disposed on the spacing pins 250, and may be stably placed on the spacing pins 250 according to the movement of the transport unit.

When the above process is completed, the transport unit returns to the outside, and the first driver 240 may lower the support plate 231. The first driver 240 may lower the support plate 231 to a set or predetermined position and may fix the support plate 231.

The controller 293 operates the moving part 220 to join the first housing 211 and the second housing 212 and thus, the controller 293 may close the chamber 210. As described above, the sealing portion 213 may prevent the introduction of the outside air into the chamber 210.

When the chamber 210 is closed, the controller 293 operates the suction pump 282 to decompress the atmosphere in the chamber 210. The gas sensing unit 291 may detect the gas generated during the drying of the treatment solution on the substrate S.

Specifically, the light emitted from the light source part 291a may have a set or predetermined wavelength and intensity. In this case, when the inside of the chamber 210 is decompressed, gas may be generated from the treatment solution, and the wavelength and intensity of the light emitted from the light source part 291a may vary due to the refraction or reflection of the light inside the gas-filled chamber.

The optical sensor part 291b may measure the variation in the wavelength and intensity of the light. The optical sensor part 291b transmits the measured wavelength and intensity of the light to the controller 293, and the controller 293 may determine the concentration of the gas, the amount of the generated gas, or the kind of the gas based on the transmitted wavelength and intensity of the light.

As described above, the controller 293 may display data of the gas, which is measured in real time, to the outside on a display unit 295. In addition, the controller 293 may determine whether the drying process has ended or not, based on a calculated gas concentration, and may determine the presence of abnormalities in the drying process by calculating a gas generation rate based on the amount of the generated gas. Since a method of determining whether the drying process has ended or not, or determining the presence of the abnormalities in the drying process based on the measured data of the gas by the controller 293 is similar to the description above, a more detailed description thereof is not provided again.

When the drying process is determined to be abnormal based on the measured gas generation rate, the controller 293 may control the decompression unit 280. Since a method in which the controller 293 controls the decompression unit 280 is identical or similar to the description above, a more detailed description thereof is not provided again.

Also, when the drying process is determined to have ended, the controller 293 may stop the operation of the suction pump 282 and may operate the supply pump 272 to provide the treatment gas into the chamber 210.

When the pressure in the chamber 210 is identical or similar to the atmospheric pressure due to the treatment gas, the moving part 220 may open the chamber 210 by lifting the first housing 211. In this case, the controller 293 may control the first driver 240 to raise the support plate 231.

When the chamber 210 is opened, the transport unit is inserted and may unload the substrate S to the outside. In this case, the controller 293 may control the first driver 240 to lower the support plate 231.

Therefore, the vacuum drying apparatus 200 may monitor and analyze the gas generated during the drying of the treatment solution by measuring the gas in real time. Also, the vacuum drying apparatus 200 may be controlled based on the gas concentration and the gas generation rate, and thus, the vacuum drying apparatus 200 may perform the drying of the treatment solution under suitable or optimum process conditions.

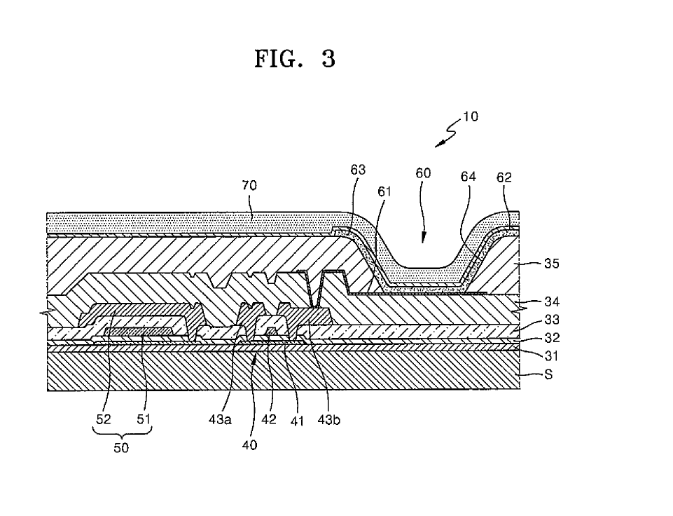

FIG. 3 is a cross-sectional view illustrating a display apparatus 10 manufactured using the vacuum drying apparatuses 100 and 200 according to an embodiment of the present invention.

Referring to FIG. 3, the display apparatus 10 manufactured using one or more of the vacuum drying apparatuses 100 and 200 may be variously formed. For example, the display apparatus 10 may include a liquid crystal display apparatus, a plasma display apparatus, or an organic light-emitting display apparatus. Hereinafter, the embodiments of the present invention will be described in more detail for a case where the display apparatus 10 includes an organic light-emitting display apparatus for convenience in description and hereafter referred to as “organic light-emitting display apparatus”.

One or more of the vacuum drying apparatuses 100 and 200 may be variously used during the manufacture of the organic light-emitting display apparatus 10. For example, the vacuum drying apparatuses 100 and 200 may be used for drying a treatment solution on a substrate S after coating the surface of the substrate S with the treatment solution, such as a resist solution, during a photomask process for forming a pattern on the substrate S. However, the use of the vacuum drying apparatuses 100 and 200 is not limited thereto. The vacuum drying apparatuses 100 and 200 may also be used in a drying process when an organic emission layer to be described later is formed by a printing process or an encapsulation layer 70 is formed. In particular, the use of the vacuum drying apparatuses 100 and 200 is not limited thereto, and the vacuum drying apparatuses 100 and 200 may be used in all processes of drying the treatment solution coated on the substrate S during the process of manufacturing the display apparatus 10. However, hereinafter, the embodiments of the present invention will be described in more detail for a case where the treatment solution is a material that constitutes an intermediate layer 63 by using an inkjet process among printing processes for convenience in description.

The organic light-emitting display apparatus 10 is formed on a substrate S. The substrate S may be formed of a glass material, a plastic material, or a metallic material. A buffer layer 31 containing an insulator may be formed on the substrate S so as to provide a flat surface on the substrate S and prevent the penetration of moisture and foreign matter into the substrate S.

A thin film transistor (TFT) 40, a capacitor 50, and an organic light-emitting device 60 are formed on the buffer layer 31. The TFT 40 mainly includes an active layer 41, a gate electrode 42, a source electrode 43a, and a drain electrode 43b. The organic light-emitting device 60 includes a first electrode 61, a second electrode 62, and the intermediate layer 63.

The active layer 41, the gate electrode 42, the source electrode 43a, the drain electrode 43b, the first electrode 61, and the second electrode 62 may be formed by using various suitable methods. In particular, the active layer 41, the gate electrode 42, the source electrode 43a, the drain electrode 43b, the first electrode 61, and the second electrode 62 may be formed through a photolithography process.

The substrate S having a raw material formed thereon is coated with a resist solution, and the photolithography process may then be performed through a number of suitable processes, such as developing after exposure using a photomask, etching, stripping, or ashing. In this case, after the substrate S is coated with the resist solution, the resist solution is dried using the vacuum drying apparatuses 100 and 200, and the above processes may then be performed. In particular, since a method of manufacturing the active layer 41, the gate electrode 42, the source electrode 43a, the drain electrode 43b, the first electrode 61, and the second electrode 62 through the photolithography process is identical or similar to a generally known technique, a detailed description thereof is not provided again.

The active layer 41 formed in a set or predetermined pattern is disposed on the buffer layer 31. The active layer 41 may include a semiconductor material, in which a p-type or n-type dopant is included. The active layer 41, including the semiconductor material, may be formed of polysilicon. However, the embodiments of the present invention are not limited thereto. The active layer 41 may be formed of an oxide semiconductor. For example, the oxide semiconductor may include an oxide of a material selected from the group consisting of Group 12, 13, and 14 metal elements (such as zinc (Zn), indium (In), gallium (Ga), tin (Sn), cadmium (Cd), germanium (Ge), and hafnium (Hf), or a combination thereof). For example, the active layer 41 may include (In₂O₃)ₐ(Ga₂O₃)_{b}(ZnO)_{c} (IGZO) (where a, b, and c are real numbers respectively satisfying a≧0, b≧0, and c>0).

A gate dielectric layer 32 is formed on the active layer 41. The gate electrode 42 is formed on the gate dielectric layer 32 to correspond to the active layer 41. An interlayer dielectric 33 is formed to cover the gate electrode 42. In addition, the source electrode 43a and the drain electrode 43b are formed on the interlayer dielectric 33, wherein the source electrode 43a and the drain electrode 43b are formed to be in contact with set or predetermined areas of the active layer 41. A passivation layer 34 is formed to cover the source electrode 43a and drain electrode 43b, and a separate insulating layer may be further formed on the passivation layer 34 for the planarization of the TFT 40.

The first electrode 61 is formed on the passivation layer 34. The first electrode 61 is formed to be electrically connected to the drain electrode 43b. A pixel-defining layer 35 is formed to cover the first electrode 61. A set or predetermined opening 64 is formed in the pixel-defining layer 35, and the intermediate layer 63, including an organic emission layer, is then formed in a region that is limited by the opening 64. The second electrode 62 is formed on the intermediate layer 63.

The organic emission layer may be formed in various suitable configurations. For example, the organic emission layer is formed in the opening 64, and sub-pixels emitting red, green, and blue light may constitute a single unit pixel. Also, the organic emission layer may be commonly formed on the entire pixel-defining layer 35 regardless of a position of the pixel. In this case, the organic emission layer may be formed by vertically stacking or combining layers including light-emitting materials that emit red, green, and blue light. If the organic emission layer emits white light, the combination of different colors may be possible. In this case, a color conversion layer for converting the emitted white light into a set or predetermined color or a color filter may be further included.

A method of forming the intermediate layer 63, including the organic emission layer, may be any one of various suitable methods. For example, a typical deposition process or printing process may be used. In this case, after the above process is performed, the intermediate layer 63 may then be formed by drying using the vacuum drying apparatuses 100 and 200.

Sealing may be performed by forming the encapsulation layer 70 on the second electrode 62 or using an encapsulation substrate. In this case, the encapsulation substrate may be formed identically or similarly to the substrate S. Also, the encapsulation layer 70 may be formed in the form of a thin film. However, hereinafter, the embodiments of the present invention will be described in more detail for a case where the encapsulation layer 70 is formed on the second electrode 62 for convenience in description.

The encapsulation layer 70 may be formed by alternatingly stacking one or more organic layers and one or more inorganic layers. The inorganic layer or the organic layer may each be included in plurality.

The organic layer is formed of a polymer, and may be a single layer or a multi-layer formed of any suitable materials (such as polyethylene terephthalate, polyimide, polycarbonate, epoxy, polyethylene, or polyacrylate). For example, the organic layer may be formed of polyacrylate and specifically, may include a polymerized monomer composition including a diacrylate-based monomer and a triacrylate-based monomer. A monoacrylate-based monomer may be further included in the monomer composition. Also, a known photoinitiator, such as trimethyl benzoyl diphenyl phosphine oxide (TPO), may be further included in the monomer composition. However, the embodiments of the present invention are not limited thereto.

The inorganic layer may be a single layer or a multi-layer including metal oxide or metal nitride. Specifically, the inorganic layer may include any one of SiNₓ, Al₂O₃, SiO₂, and TiO₂.

An uppermost layer of the encapsulation layer 70 that is exposed to the outside may be formed of an inorganic layer in order to prevent the penetration of moisture into the intermediate layer 63.

The encapsulation layer 70 may include at least one sandwich structure in which at least one organic layer is inserted between at least two inorganic layers. Also, the encapsulation layer 70 may include at least one sandwich structure in which at least one inorganic layer is inserted between at least two organic layers.

The encapsulation layer 70 may sequentially include a first inorganic layer, a first organic layer, and a second inorganic layer from the top of the second electrode 62. Also, the encapsulation layer 70 may sequentially include a first inorganic layer, a first organic layer, a second inorganic layer, a second organic layer, and a third inorganic layer from the top of the second electrode 62.

The encapsulation layer 70 may sequentially include a first inorganic layer, a first organic layer, a second inorganic layer, a second organic layer, a third inorganic layer, a third organic layer, and a fourth inorganic layer from the top of the second electrode 62.

A metal halide layer, including LiF, may be further included between the second electrode 62 and the first inorganic layer. The metal halide layer may protect the second electrode 62 from being damaged when the first inorganic layer is formed.

The first organic layer has an area that is smaller than that of the second inorganic layer. The second organic layer may also have an area that is smaller than that of the third inorganic layer. Also, the first organic layer is completely covered with the second inorganic layer, and the second organic layer may also be completely covered with the third inorganic layer.

Therefore, when the vacuum drying apparatuses 100 and 200 are used, the display apparatus 10 may be rapidly manufactured. In addition, with respect to the display apparatus 10 manufactured using the vacuum drying apparatuses 100 and 200, because surface uniformity after the drying of the treatment solution may be secured by reducing or minimizing air bubbles generated during the drying of the treatment solution, the failure rate in a process of using the treatment solution may be reduced or minimized.

In addition, since the vacuum drying apparatuses 100 and 200 may perform the drying process under suitable or optimum process conditions, drying time and energy required during the drying may be saved.

As described above, according to the one or more of the above embodiments of the present invention, gas generated during drying of a treatment solution may be monitored and analyzed by measuring the gas in real time. Also, the vacuum drying apparatuses may be controlled based on the gas concentration and the gas generation rate, and thus, the drying of the treatment solution may be performed under suitable or optimum process conditions.

It should be understood that the example embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims, or equivalents thereof.

What is claimed is:

1. A vacuum drying apparatus comprising:
a chamber having a space formed therein;
a support unit installed in the chamber to stably support a substrate coated with a treatment solution;
a gas injection unit connected to the chamber to inject a treatment gas into the chamber;
a decompression unit connected to the chamber to decompress the chamber; and
a gas sensing unit with at least one of the chamber and the decompression unit to detect gas generated during drying of the treatment solution.

2. The vacuum drying apparatus of claim 1, wherein the chamber comprises:
a first housing; and
a second housing separably joined with the first housing.

3. The vacuum drying apparatus of claim 2, further comprising:
a moving part connected to the first housing to detach the first housing from the second housing.

4. The vacuum drying apparatus of claim 1, wherein the support unit comprises:
a support plate to support the substrate; and
a support shaft to support the support plate.

5. The vacuum drying apparatus of claim 1, further comprising:
seating pins installed in the chamber to support the substrate.

6. The vacuum drying apparatus of claim 1, wherein the decompression unit comprises:
a suction pipe connected to the chamber to guide gas in the chamber to the outside; and
a suction pump installed on the suction pipe.

7. The vacuum drying apparatus of claim 6, wherein the gas sensing unit is installed on the suction pipe.

8. The vacuum drying apparatus of claim 1, wherein the gas sensing unit is installed on an upper side of the chamber.

9. The vacuum drying apparatus of claim 1, further comprising a controller to control an operation of the decompression unit based on a gas concentration detected by the gas sensing unit.

10. The vacuum drying apparatus of claim 9, wherein the controller is configured to stop the operation of the decompression unit when the gas concentration is less than a set concentration.

11. The vacuum drying apparatus of claim 10, wherein the controller is configured to operate the gas injection unit to inject the treatment gas into the chamber when the operation of the decompression unit is stopped.

12. The vacuum drying apparatus of claim 9, wherein the controller is configured to calculate a gas generation rate and control the operation of the decompression unit based on the calculated gas generation rate.

13. The vacuum drying apparatus of claim 12, wherein the controller is configured to control the operation of the decompression unit to increase pressure in the chamber when the gas generation rate is determined to exceed a set rate.

14. A method of manufacturing a display apparatus, the method comprising:
coating a substrate with a treatment solution;
loading the substrate into a chamber; and
drying the treatment solution on the substrate while decompressing the chamber,
wherein at least one of a gas in the chamber and a gas discharged from the chamber is measured in the drying of the treatment solution.

15. The method of claim 14, wherein the chamber comprises a first housing and a second housing separably joined with the first housing,
wherein the method further comprises loading the substrate in a state in which the first housing and the second housing are separated, and joining the first housing and the second housing after the loading of the substrate is completed.

16. The method of claim 14, further comprising:
injecting a treatment gas into the chamber when a gas concentration in the chamber is less than a set concentration.

17. The method of claim 14, further comprising:
calculating a gas generation rate in the chamber.

18. The method of claim 17, further comprising:
maintaining or increasing pressure in the chamber when the gas generation rate is determined to exceed a set rate.

19. The method of claim 14, further comprising:
displaying a measured amount of the gas.

20. The method of claim 14, wherein the measurement of the gas is performed on an upper side of the chamber.
